(19) United States
(12) Patent Application Publication
(10) Pub. No.: US 2002/0001392 A1
(43) Pub. Date: Jan. 3, 2002

(54) Loudspeaker system and noise canceling apparatus

(76) Inventors: Junichi Isono, Tokyo (JP); Masashi Hori, Kanagawa (JP)

Correspondence Address: PEPPER HAMILTON LLP, 600 FOURTEENTH STREET, N.W., WASHINGTON, DC, 20005-2004, US

(21) Appl. No.: 09/893,678

(22) Filed: Jun. 29, 2001

(30) Foreign Application Priority Data
Jun. 30, 2000 (JP) 2000-199817

(51) Int. Cl. H04R 9/08; H04R 11/04

(52) U.S. Cl. 381/431; 381/355

(57) ABSTRACT

In a loudspeaker system of the present invention, a plurality of flat loudspeaker units are arranged and fixed linearly in the longitudinal direction of an elongated opening provided at a side portion of a cabinet to form a base unit. In such a manner, a series of sound sources extending linearly can be achieved, and at the same time, sounds output from the flat loudspeaker units are synthesized to thereby increase the energy. Accordingly, a listener can listen to sounds under the same condition anywhere along the cabinet. Moreover, the loudspeaker system of the present invention has an effect in that the sound is not perceived as noisy even in a position close to the loudspeaker while the sound is perceived as clearly in a position far from the loudspeaker as it is perceived in the closer position.

### BACKGROUND OF THE INVENTION

1. Field of the Invention

The present invention relates to a loudspeaker system and a noise canceling apparatus. More specifically, the present invention relates to a loudspeaker system in which a predetermined number of flat loudspeaker units are disposed in a coupled manner in the longitudinal direction of a cabinet, wherein the flat loudspeaker unit is structured with a plurality of small sound cells placed vertically and horizontally, and to a noise canceling apparatus for canceling noises using this loudspeaker system.

2. Description of the Related Art

Loudspeakers for commercial use and those for household use are generally of cone type. Normally, this type of loudspeaker is used such that a plurality of such loudspeakers are arranged in a certain place in a manner that is suitable for that space.

According to such conventional art, there have been problems in that locations at which these loudspeakers can be installed are limited by the size of the loudspeaker and/or the condition of the installation space, and that when loud sounds are required in a large space, the size of the loudspeaker must be large.

Moreover, there has been another problem in that since the installation place of the loudspeaker is a source of the sound, the sound source will be a point sound source, so that the volume and tone sound different depending on a position of a listener.

Further, there has been another problem in that the sound might be deformed and/or distorted depending on the spatial condition.

### SUMMARY OF THE INVENTION

In order to solve the aforementioned problems, a loudspeaker system of the present invention includes a plurality of flat loudspeaker units arranged and fixed linearly in the longitudinal direction of an elongated opening provided at a side portion of a cabinet, wherein the plurality of flat loudspeaker units form a base unit.

According to the loudspeaker system of the present invention, since the plurality of flat loudspeaker units are arranged and fixed linearly in the longitudinal direction of the elongated opening provided at a side portion of the cabinet, a series of sound sources extending linearly can be obtained.

Moreover, by arranging the plurality of flat loudspeaker units linearly, sounds output from the flat loudspeaker units are synthesized to thereby increase the energy.

The loudspeaker system of the present invention has an effect of making it possible for a listener to hear sounds having the same quality anywhere along the cabinet, and that the sound is not perceived as noisy even in a position close to the loudspeaker and is also perceived as clearly in a position far from the loudspeaker as it is perceived in the closer position since the loudspeaker system of the present invention outputs sounds with plane waves having little attenuation unlike loudspeaker systems with cone loudspeakers.

A noise canceling apparatus, which is another aspect of the present invention, utilizes the above-described loudspeaker system and outputs a sound having an opposite phase to a sound picked up by a microphone from the flat loudspeaker unit, thereby enabling it to cancel noises and the like.

In the noise canceling apparatus of the present invention, the position of a diaphragm of the microphone and the position of a driving plate of the flat loudspeaker unit are in the same plane, so that noises can be canceled with a simple structure and does not require any complex control.

### BRIEF DESCRIPTION OF THE DRAWINGS

FIG. 1 is a partial front view for explanation of a base unit in a state in which a cover is off.

FIG. 2 is a partial side view for explanation of the base unit in a state in which the cover is on.

FIG. 3 is a cross-sectional view along line A-A in FIG. 2.

FIG. 4 is a diagram for explanation showing a state of a partition and a sound absorbing material.

FIGS. 5A, 5B, and 5C are diagrams for explanation showing examples of shapes of a connecting material.

FIG. 5D is a side view of a loudspeaker system in which the base units are connected by using the connecting materials.

FIG. 6 is an exploded view of a base unit according to a second embodiment.

FIG. 7 is a cross-sectional view of the base unit according to the second embodiment.

FIG. 8A is a side view of a baffle board seen from a projection side.

FIG. 8B is a side view of the baffle board seen from a side surface side of a rib.

FIG. 8C is a back view of the baffle board.

FIG. 9 is a diagram for explanation showing the baffle boards in a connected state.

FIG. 10 is a front view of a bracket.

FIG. 11 is a side view of the bracket.

FIG. 12 is a cross-sectional view of the base unit showing a mounting portion of a speaker grille.

FIG. 13 is a cross-sectional view of a base unit according to a third embodiment.

FIG. 14 is a diagram for explanation showing a placement of the base unit when reducing noises.

FIG. 15 is a diagram for explanation in a case in which the base units are mounted to sound-proof walls of a road.

FIG. 16 is a cross-sectional view of a base unit according to a fourth embodiment.

FIG. 17 is a diagram for explanation showing a placement of the base unit when reducing noises.

FIG. 18 is an exploded perspective view of a flat loudspeaker unit.

FIG. 19 is a cross-sectional view of the flat loudspeaker unit.

### DETAILED DESCRIPTION OF THE PREFERRED EMBODIMENTS

[First Embodiment]

Referring to the drawings, a first embodiment of the present invention will be described hereinafter.

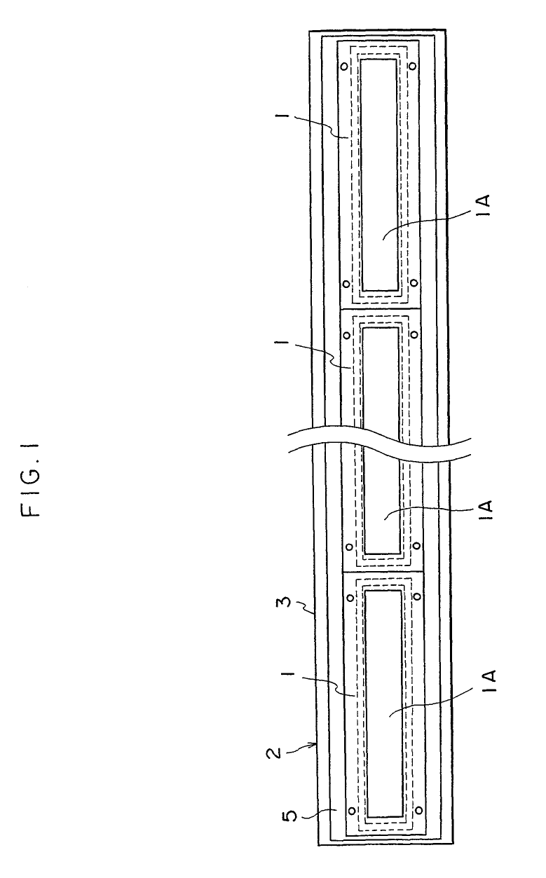

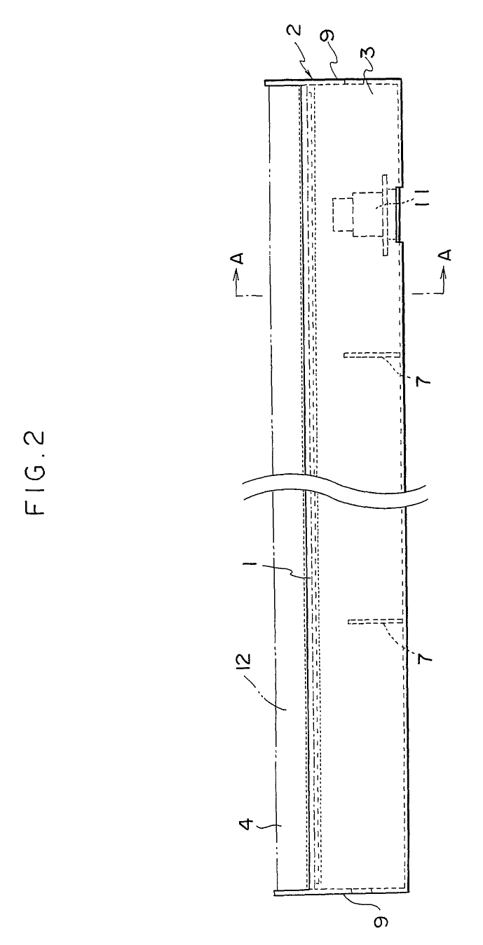

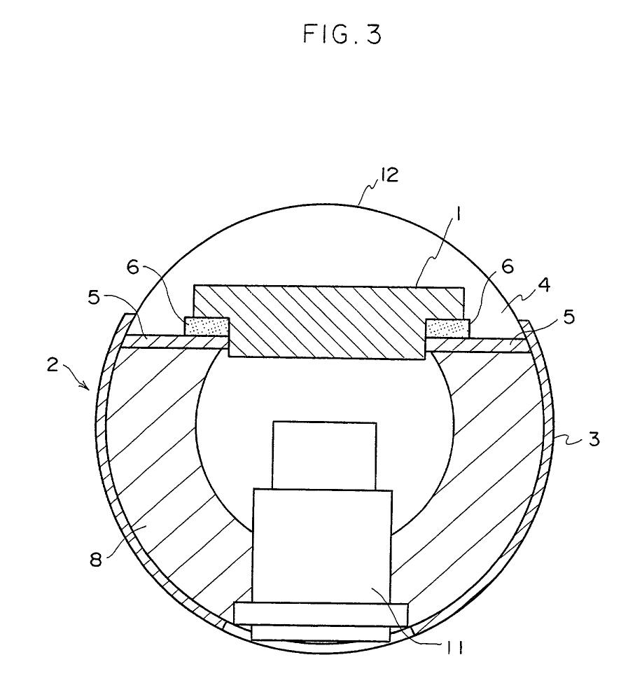

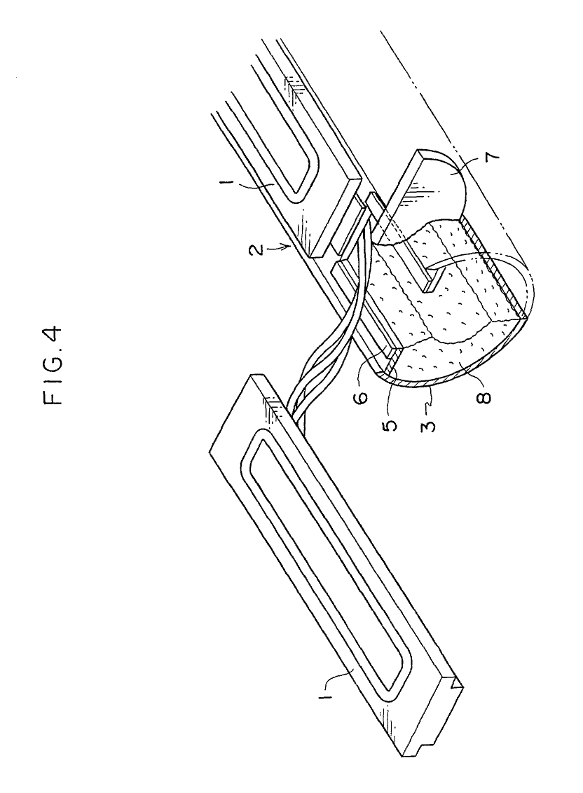

FIG. 1 is a partial front view for explanation of a base unit 2 in a state in which flat loudspeaker units 1 are disposed in a pipe 3. FIG. 2 is a partial side view for explanation of the base unit 2 and FIG. 3 is a cross-sectional view for explanation of the base unit 2.

A loudspeaker referred to as a multi-cell flat loudspeaker described in, for example, PCT/JP00/03755 and others can be used as the flat loudspeaker unit 1. These loudspeakers vary in size and all of them can be used.

The present embodiment will be described using the flat loudspeaker unit 1 having a size of 40 mm in length, 160 mm in width, and 6 mm in thickness.

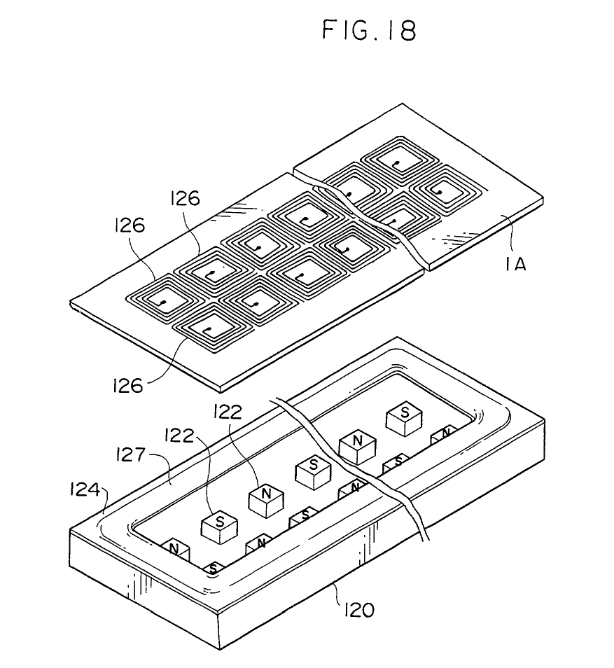

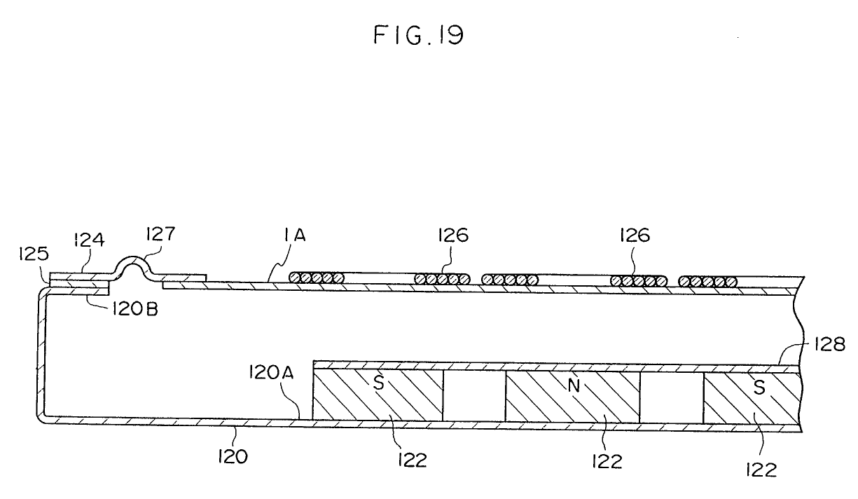

As shown in FIGS. 18 and 19, the flat loudspeaker unit 1 is provided with a yoke 120 consisting of a flat member formed of a magnetic substance.

On a magnet fixing portion 120A of the yoke 120, a plurality of permanent magnets 122 with a flat rectangular shape are fixedly disposed by adhesion in a manner in which pole faces having different polarity are placed alternately at predetermined intervals, and the pole face of each magnet faces upward as shown in FIGS. 18 and 19.

On an upper surface side of the yoke 120, a diaphragm 1A is disposed in close vicinity to the pole faces in such a manner that the diaphragm is parallel to the pole face of the permanent magnets 122, and thus to the upper surface of the yoke 120.

On a diaphragm mounting portion 120B of the yoke 120, an outer peripheral edge of a frame body 124 with a rectangular frame shape is fixed with a spacer 125 made of paper or the like provided therebetween.

On the frame body 124, an edge 127, which is a resilient portion having a semi-circular arcuate cross-section, is formed continuously along the outer peripheral edge.

An outer peripheral edge of the diaphragm 1A is adhered to an inner edge side of the frame body 124.

On the diaphragm 1A, spirally formed coils 126 are disposed so as to correspond to each of the permanent magnets 122.

Each coil 126 is formed with a spirally winding structure so as to have a configuration substantially similar to the outer edge of the permanent magnet 122.

Moreover, in order to form an air layer with a predetermined thickness between the permanent magnets 122 and the diaphragm 1A, the pole face of the plurality of permanent magnets 122 is covered with a sheet material 128 adhered thereto.

On each coil 126, magnetic fluxes facing a substantially parallel direction with respect to the diaphragm surface are interlinked.

When an electric current passes through the coil 126, the diaphragm 1A is subjected to a force perpendicular to the surface of the diaphragm, so that the diaphragm 1A is displaced in a direction perpendicular to the surface of the diaphragm.

Therefore, by energizing the coil 126 with electric signals that indicate sounds that are to be generated, the diaphragm 1A is vibrated according to the electric signals to thereby enable sound signals to be generated.

In the present embodiment, twelve flat loudspeaker units 1 are disposed in a connected row arrangement and fixed in the pipe 3 to thereby form a single base unit 2.

In accordance with the present invention, there is no limitation on the number of the flat loudspeaker units 1 provided in a connected row arrangement and, for example, two, four, eight, or twenty-four flat loudspeaker units 1 may be disposed in a connected row arrangement and fixed in the pipe 3.

While the base unit 2 can be used alone, any desired number of the base units 2 may be connected and used together.

Moreover, the plurality of flat loudspeaker units 1 may either be electrically connected serially or in parallel, or may be connected by combining serial and parallel connections.

According to the above-described dimension of the flat loudspeaker unit 1, when the total length of the base unit 2 is set to 170 cm, the base unit 2 functions as a resonant pipe to amplify the frequency band with a resonance frequency of 49 Hz, 147 Hz, and 245 Hz. Thus, the low frequency band can be amplified.

In connecting each of the flat loudspeaker units 1 to form the base unit 2, the narrower the space between each of the flat loudspeaker units 1, the better the synthesis of the high frequency band. Thus, in the present embodiment, the flat loudspeaker units 1 are connected along the longitudinal direction of the pipe 3 as shown in FIG. 1, wherein the space between each of the diaphragms 1A is 14 mm, thereby enabling smooth synthesis of the high frequency band for a synthesized frequency of up to 24000 Hz.

Further, to withstand the large sound volume, the distance between the diaphragm 1A and the permanent magnet 122 of the flat loudspeaker unit 1 is widened (0.2 mm in the present embodiment), and accordingly, the magnetic flux density of the permanent magnet 122 is made higher thus improving the performance of the material of the diaphragm 1A.

As a specific structure of the base unit 2, the material of the pipe 3 could be any material such as metal, wood, paper, synthetic resin and the like. An opening 4 is provided in the side portion in the longitudinal direction of the pipe 3 having a desired diameter (an internal diameter of 50 mm in the present embodiment), and a fixing portion 5 is formed at the inner periphery of the opening 4.

The cross-sectional form of the pipe 3 can be of any shape such as circular, elliptical, polygonal and the like.

The fixing portion 5 is a portion which fixes the flat loudspeaker units 1 disposed in a connected row arrangement, and any fixing means may be used. For example, the flat loudspeaker units 1 may be fixed, by being screwed directly or via an anchoring member, and are fixed by disposing a resonance preventing material 6 made of an elastic material such as a rubber board, a synthetic resin board, a cork board, or the like between the flat loudspeaker units 1 and the fixing portion 5.

Depending on the wall thickness of the pipe, the flat loudspeaker units 1 may be fixed directly on the end face of the opening without forming the fixing portion 5.

In some cases, the flat loudspeaker units 1 may also be fixed by using an adhesive agent rather than by being screwed or the like.

In the pipe 3, it is preferable if partitions 7 are formed at the connecting points in order to prevent an acoustic resonance for each flat loudspeaker unit 1. The partition 7 may either divide the space within the pipe 3 completely by filling the entire inner perimeter of the pipe 3, or a space may be left between the upper edge of the partition 7 and the back surface of the flat loudspeaker unit 1.

It will also be advantageous if a sound absorbing material 8 is provided in the pipe 3 in order to reduce an internal resonance of a low frequency band.

The sound absorbing material 8 may either fill the space within the pipe 3, or a space may be left below the back surface of the flat loudspeaker unit 1. In either case, the structure must be such that wiring can be passed through.

The both ends of the pipe 3 of the base unit 2 or a small unit are closed with shutoff boards 9. On the shutoff board 9, a small wiring hole (not shown) is formed.

In order to connect such base units 2 or small units, bolts and nuts, or the like are used to fixedly couple them tightly.

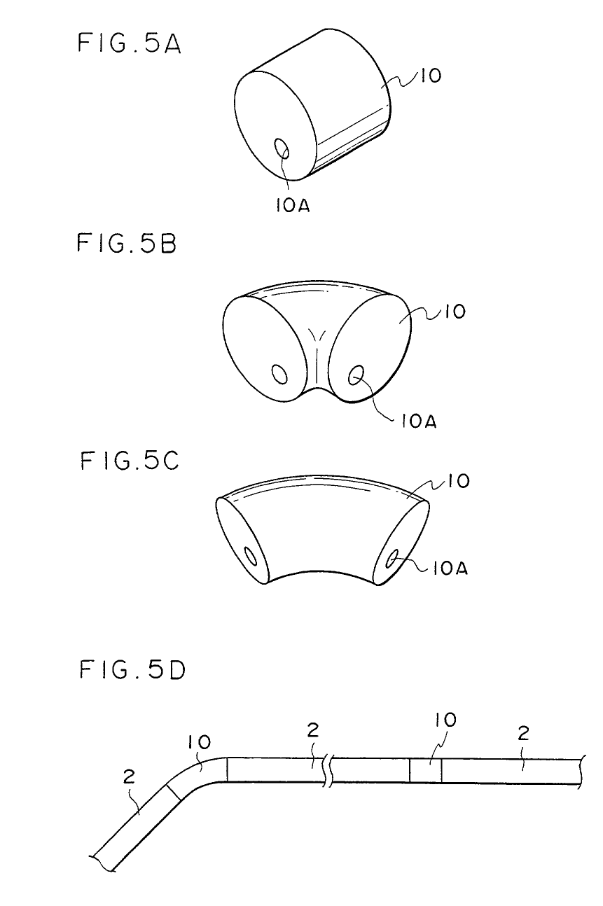

In connecting the base units 2, a connecting material 10 such as one shown in FIGS. 5A to 5C may be disposed between the base units 2. The total length of the loudspeaker system can be adjusted by adjusting the length of the connecting material 10.

It is structurally advantageous for total length of the base unit 2 be 180 cm when it is being at the installation site in light of architectural dimensions. However, the length of the base unit 2 may be suitably determined according to the purpose, and is not limited to 180 cm.

Moreover, as shown in FIGS. 5A to 5C, the connecting material 10 may not only have a linear shape but can be deformed by being bent or curved with a desired angle, thereby allowing it to be connected at the connecting portion with a desired curved angle. Accordingly, the loudspeaker system can be bent at each base unit 2 or small unit, as shown in FIG. 5D, according to the installation location.

At the desired position in the pipe 3, a connector 11 for connecting a loudspeaker cable is built-in.

On the connecting material 10, a through hole 10A for passing the wiring therethrough, which is used in connecting the flat loudspeaker unit 1 of one base unit 2 and that of another base unit 2, is formed.

A transformer for a high impedance transmission may also be installed inside the connecting material 10.

A cover 12 formed of a perforated metal, a mesh body, or the like having innumerable small holes is mounted to the opening 4 in the side portion of such pipe 3, where the flat loudspeaker units 1 are mounted, to thereby form an output surface 4.

This output surface 4 may have a curved shape in accordance with the curved surface when the pipe 3 is a cylinder, or if the pipe 3 has another shape, the output surface may accordingly have a matching shape. However, the shape of the output surface 4 does not have to match the shape of the pipe 3, and any desired shape such as a curved surface or a flat surface may be applicable.

In accordance with the loudspeaker system having the above-described structure, the sounds output from the flat loudspeaker units 1 are synthesized due to the plurality of serially-arranged flat loudspeaker units 1 in the pipe, thereby increasing the energy.

Therefore, the loudspeaker system according to the present embodiment may, as a matter of course, be used as a loudspeaker which is an ordinary acoustic equipment, but it also can be used as a broadcasting equipment in larger spaces such in the vicinity of an escalator, on a platform in a station, or at an airport by utilizing the characteristic of a sound source having a particular shape or having a linear shape which outputs plane waves. That is, the characteristic is utilized which, because the listener can hear the sounds all along the loudspeaker system, allows a listener to perceive the same sounds as being close all the time rather than as being loud.

Moreover, by utilizing the cylindrical shape of the base unit 2, the loudspeaker system can be used in a long range as, for example, a loudspeaker system which also serves as a hand rail.

Further, using appropriate materials and/or colors, the loudspeaker system can be disposed so as to be camouflaged.

[Second Embodiment]

A second embodiment of the present invention will be described hereinafter. The same reference numerals are used to designate identical structures with those of the first embodiment, and description thereof will be omitted.

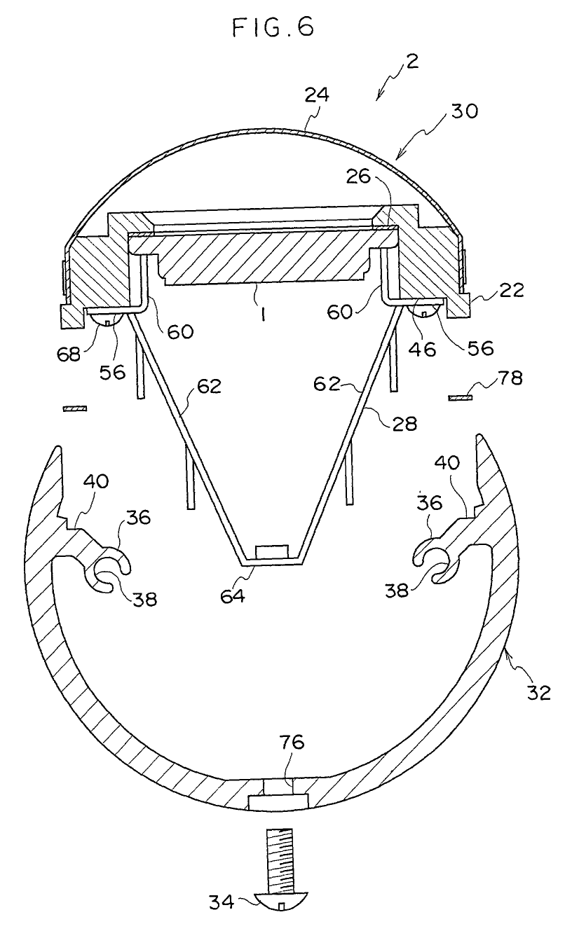

As illustrated in FIG. 6, in a base unit 20 of the present embodiment, a baffle board assembly 30 composed of a baffle board 22, the flat loudspeaker unit 1, a speaker grille 24, a resonance preventing material 26, and a bracket 28 is mounted detachably by means of a screw 34 to an extruded material 32 made of an aluminum alloy.

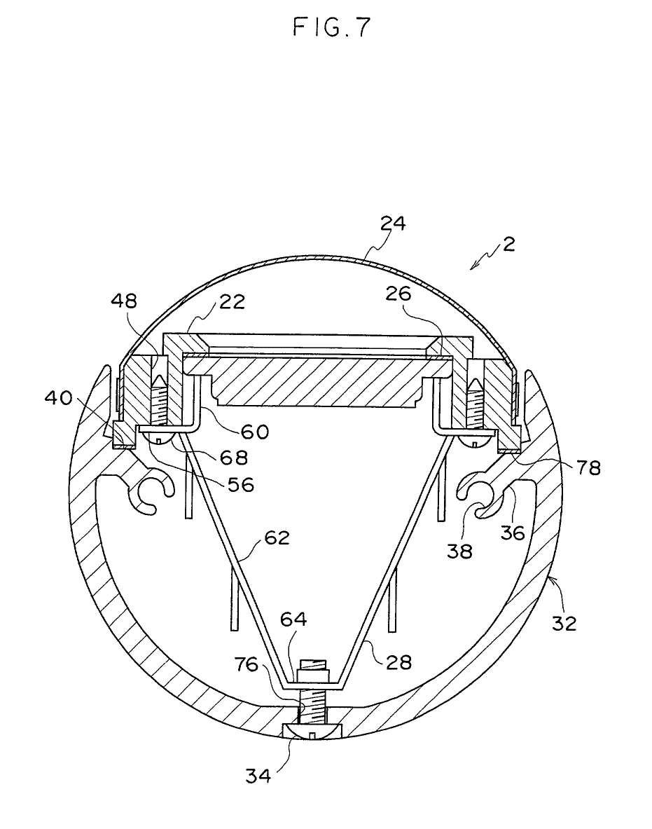

While FIG. 6 shows a state before mounting the baffle board assembly 30 to the extruded material 32, FIG. 7 shows a mounted state of the baffle board assembly 30 to the extruded material 32.

The extruded material 32 has a substantially C-shaped cross-section, and a pair of setscrew portions 36 protrude at the internal surface in the vicinity of the opening.

On the leading edge of the setscrew portion 36, a groove 38 having a substantially round cross-section is formed.

In the both longitudinal direction ends of the extruded material 32, round shutoff boards (not shown) are provided.

This shutoff board is mounted to the extruded material 32 by screwing a screw, which is passed through a hole formed on the shutoff board, into the groove 38.

At the base of the screw stop portion 36, a step portion 40 is formed.

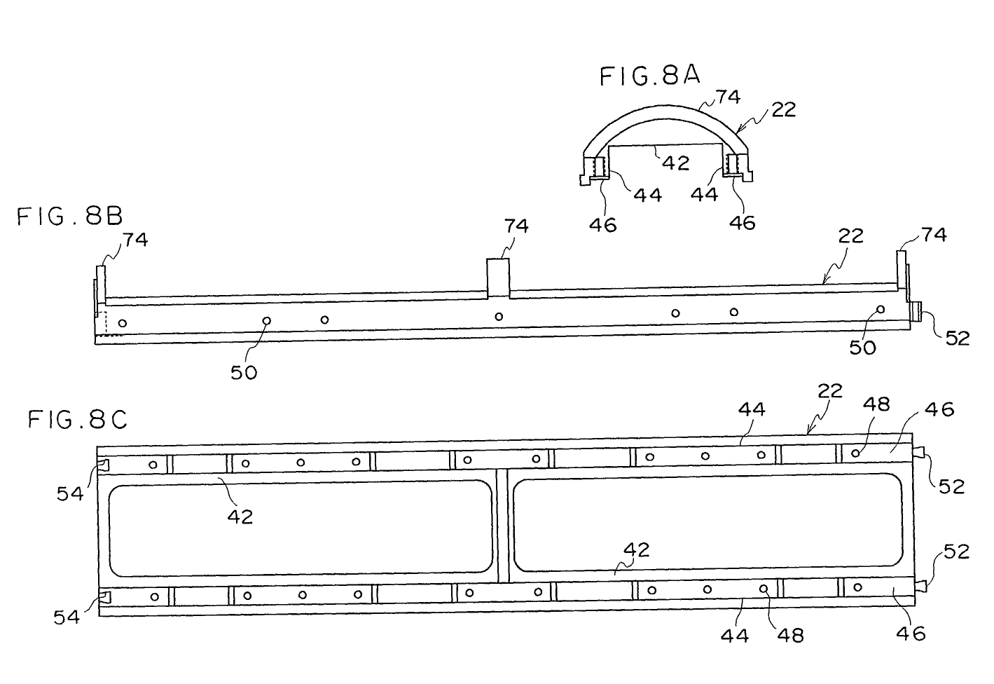

As illustrated in FIG. 8, the baffle board 22 is a molded product of synthetic resin, and is formed with a frame shape.

As shown in FIG. 8C, on the underside of the baffle board 22, a pair of loudspeaker mounting faces 42 are formed, and the central portion of each loudspeaker mounting face is open with a rectangular shape.

In the both transverse direction ends of the loudspeaker mounting face 42, ribs 44 are formed.

As shown in FIGS. 8A and 8C, on the rib 44, a bracket mounting face 46 is formed such that the bracket mounting face 46 is parallel to the loudspeaker mounting face 42.

As illustrated in FIG. 8C, on the bracket mounting face 46, a plurality of screw holes 48 are formed.

As illustrated in FIG. 8B, on the side surface of the rib 44, a plurality of screw holes 50 for screwing the speaker grille 24 (described later) are formed.

At one side in the longitudinal direction of the baffle board 22, a pair of projections 52 are formed.

At the other side in the longitudinal direction of the baffle board 22, a pair of recess portions 54 into which the projections 52 fit are formed.

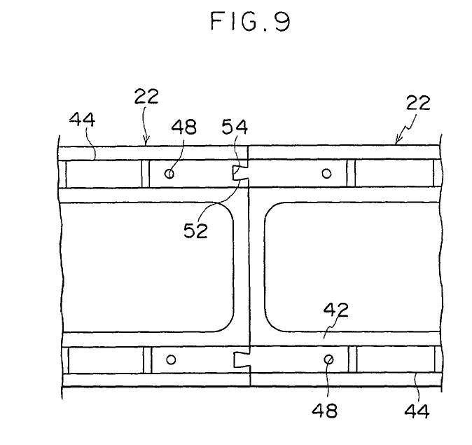

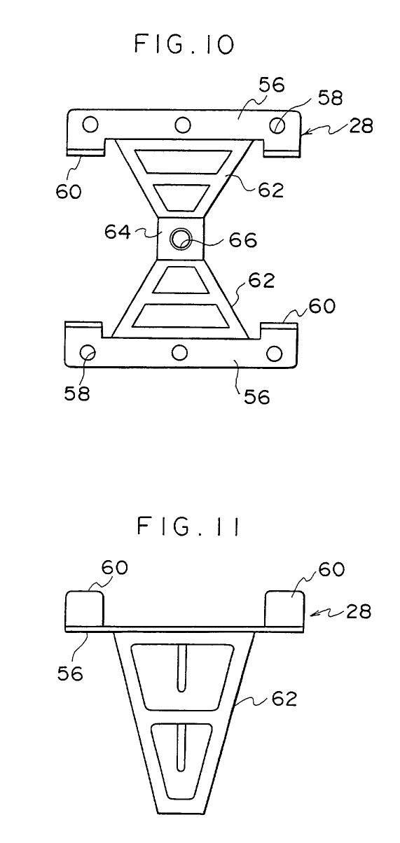

When a plurality of baffle boards 22 are connected in the longitudinal direction, the projection 52 of one baffle board 22 and the recess portion 54 of another baffle board 22 are fit together as shown in FIG. 9.

The bracket 28 is a press molded product made of a metal plate.

As illustrated in FIG. 10, the bracket 28 is provided with a board mounting portion 56 which is brought into contact with the bracket mounting face 46 of the baffle board 22. On the board mounting portion 56, a plurality of mounting holes 58 are formed.

As shown in FIGS. 6, 10 and 11, on the board mounting portion 56, loudspeaker presser pieces 60 bent at right angle and an extending portion 62 which extends so as to be inclined toward the backface side of the extruded material 32 are formed integrally.

The leading edge of one extending portion 62 and that of the other extending portion 62 are connected with each other via a connecting portion 64.

In the middle of the connecting portion 64, a female thread 66 is formed.

The flat loudspeaker unit 1 is fixed between the loudspeaker presser piece 60 and the loudspeaker mounting face 42 in a manner that the flat loudspeaker unit 1 is set in close contact with the loudspeaker mounting face 42 of the baffle board 22 via the sheet-shaped resonance preventing material 26 made of an elastic material, and a screw 68 which is passed through the mounting hole 58 on the board mounting portion 56 of the bracket 28 is screwed into the screw hole 48 formed on the bracket mounting face 46 of the baffle board 22.

Since the plurality of screw holes 48 are formed on the baffle board 22, the bracket 28 can be mounted at the desired position on the baffle board 22. For example, when a plurality of baffle boards 22 are connected in the longitudinal direction as shown in FIG. 9, the baffle boards 22 can be fixed to with each other by mounting the bracket 28 using the screw holes 48 which are closest to the connecting portion.

As illustrated in FIG. 6, at the surface side of the baffle board 22, the speaker grille 24 is provided.

This speaker grille 24 is formed by curving a perforated metal.

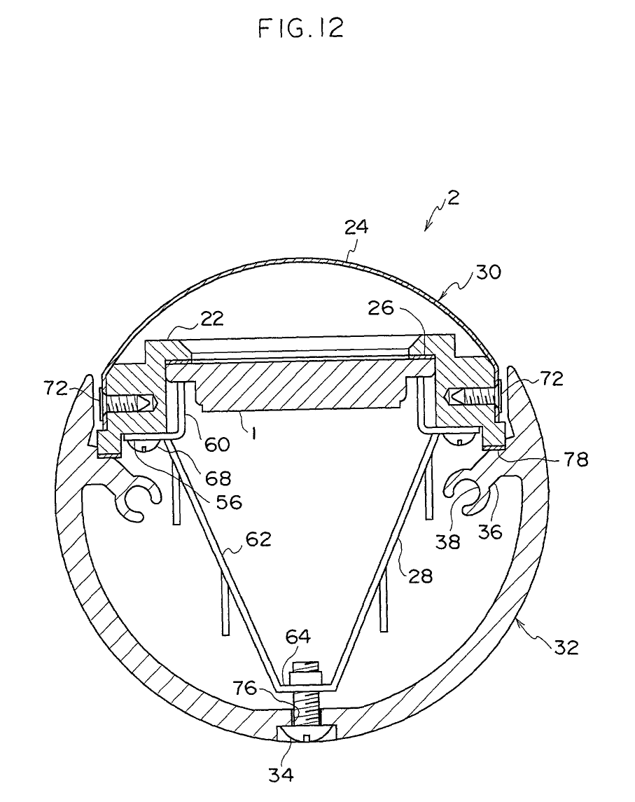

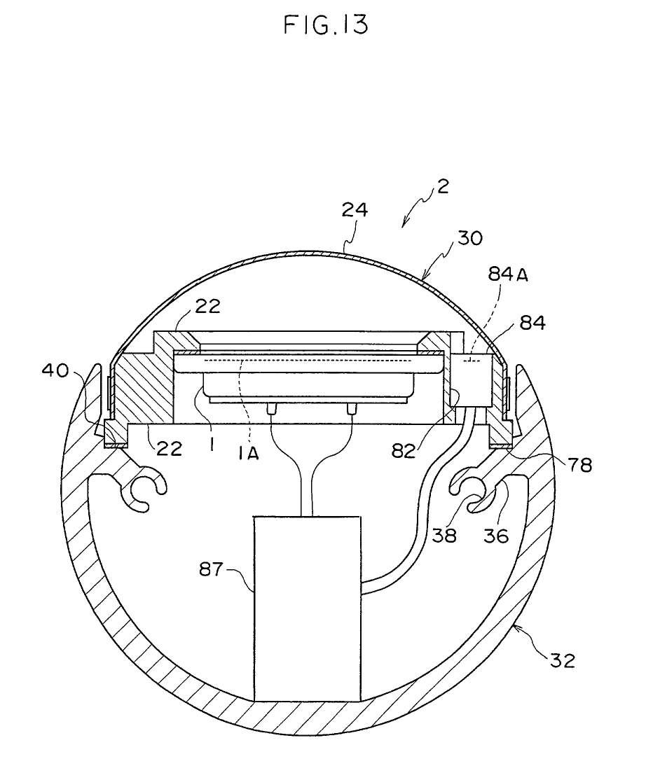

As shown in FIG. 12, the speaker grille 24 is fixed to the side surface of the rib 44 by a flat countersunk head screw 72.

As shown in FIGS. 8A and 8B, arcuate supporting portions 74 which support the speaker grille 24 from the underside are formed at the both longitudinal direction ends and at the central portion in the longitudinal direction of the baffle board 22.

As shown in FIG. 6, a mounting hole 76 is formed in the backface of the extruded material 32.

The baffle board assembly 30 is pulled toward the backface side of the extruded material 32 in a manner that the screw 34 passed through the mounting hole 76 is screwed into the screw hole 66 on the bracket 28, and the corner portion of the rib 44 is set in tight contact with the step portion 40 of the extruded material 32 with a sheet-shaped resonance preventing material 78 made of an elastic material being provided therebetween.

In the same manner as the first embodiment, the sound absorbing material 8 may be adhered to the internal surface of the extruded material 32.

In the present embodiment, the baffle board assembly 30 can be easily attached to the extruded material 32 by means of the screw 34.

Generally, loudspeakers are fixed by being screwed from the front side of a cabinet, so that a flange is formed on the frame of each loudspeaker and a plurality of mounting holes for inserting screws into the flange are formed.

Since the loudspeaker is fixed to the cabinet at the flange portion, the flange is required to have certain proportions.

Therefore, when a plurality of such loudspeakers are placed adjacent to each other, the flanges interfere with each other, preventing the diaphragms from being disposed close to each other.

At this point, when an attempt is made to output loud sounds in a large space by utilizing a plurality of loudspeakers, there will be a problem in that the high frequency band attenuates unless diaphragms are brought closer to each other.

However, in the present embodiment, since the flat loudspeaker unit 1 is not mounted from the front side by means of screws, the area of the frame of the flat loudspeaker unit 1 can be minimized and the diaphragms can be set closer to each other than in conventional methods for mounting a loudspeaker. Accordingly, even when a number of flat loudspeaker units 1 are disposed in a continuous line arrangement, attenuation of the high frequency band can be prevented.

[Third Embodiment]

A third embodiment of the present invention will be described hereinafter. The same reference numerals are used to designate identical structures with those of the above-described embodiments, and description thereof will be omitted.

As illustrated in FIG. 13, on the baffle board 22 in the base unit 2 of the present embodiment, a hole 82 passing through the baffle board 22 is formed.

A microphone 84 is inserted into the hole 82 and fixed by means of adhesive or the like.

A sound receiving surface of the microphone 84 is directed to the speaker grille side.

The microphone 84 is provided with a planar diaphragm 84A, and the diaphragm 1A of the flat loudspeaker unit 1 and the diaphragm 84A of the microphone 84 are placed in the same plane.

The microphone 84 may be a microphone having conventionally known structures such as condenser type microphone, dynamic type microphone or the like.

The base unit 2 of the present embodiment can output sound from the flat loudspeaker unit 1 and pick up the ambient sound from the microphone 84.

By using this base unit 2, a noise canceling apparatus for reducing a particular sound such as undesired noise can also be structured.

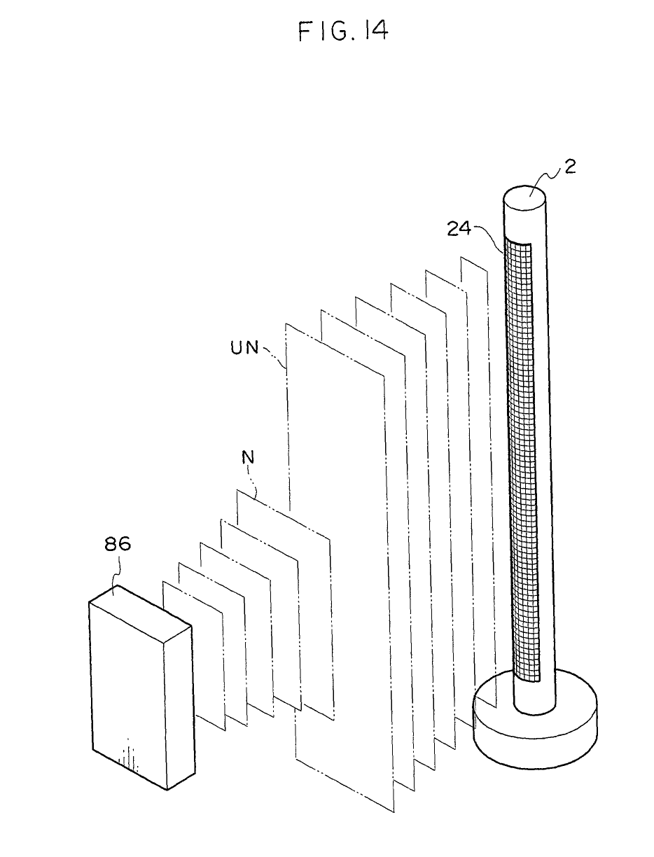

When the base unit 2 is used as the noise canceling apparatus, the front side of the base unit 2 is directed to a noise source 86, for example, and a noise N output from the noise source 86 is picked up from the microphone 84 as shown in FIG. 14. Then, signals from the microphone 84 are phase-inverted at a control circuit 87, the phase-inverted signals are amplified to be output to the flat loudspeaker unit 1, and a canceling sound UN having an opposite phase to the picked up noise N is output from the flat loudspeaker unit 1 to cancel the noise N.

Conventionally, various systems for canceling noise by picking up noise by a microphone and then by outputting a sound having an opposite phase to the noise from a loudspeaker have been made for practical use. However, those are combinations of a cone type loudspeaker and a microphone, and a diaphragm of the loudspeaker and a diaphragm of the microphone are not placed in the same plane.

A first drawback of the conventional system is, since a noise pick up position (the location of the diaphragm of the microphone) and a noise cancel sound outputting position (the location of the diaphragm of the loudspeaker) are different with respect to a point of the noise source, there has been a problem in which complicated operations are required prior to outputting sound. Moreover, the control circuit is intricate, and complex noises (such as a mixture of plural sounds having different frequency or level) cannot be reduced effectively.

However, in the noise canceling apparatus employing the base unit 2 of the present embodiment, since the location of the diaphragm 84A of the microphone 84 and the location of the diaphragm 1A of the flat loudspeaker unit 1 are set in the same plane, what is required for the control circuit 87 are only phase inversion and level control, thereby enabling cancellation of the noise N with a simple structure. When the wire connected to the flat loudspeaker unit 1 is reversed, the phase is automatically inverted.

Moreover, as a second drawback of the conventional system, since cone type loudspeakers are being used, the noise canceling sound is not a plane wave.

Accordingly, when a plurality of loudspeakers are used, the waveform of the noise canceling sound become mixed up, so that the noise canceling effect is insufficient.

However, in the base unit 2 of the present embodiment, since the diaphragms 1A of the plurality of flat loudspeaker units 1 are disposed in the same plane, plane waves can be output regardless of the number of flat loudspeaker unit 1, thereby ensuring the cancellation of the noise N.

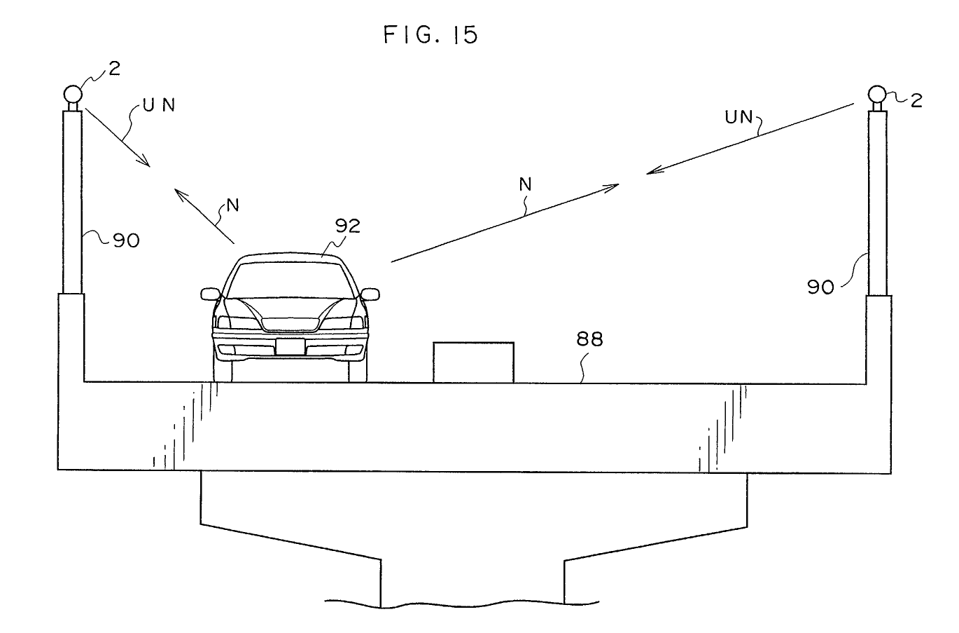

As illustrated in FIG. 15, a plurality of noise canceling apparatuses employing the base unit 2 may also be connected along the top end of sound-proof walls 90 on a road 88.

In this case, the microphone 84 picks up the noise N of a vehicle 92, and the noise canceling sound UN having an opposite phase to the picked up noise N is output from the flat loudspeaker unit 1 to thereby enable cancellation of the noise N of the vehicle 92. Accordingly, the noise N which might be heard outside the sound-proof walls 90 can be reduced.

In a single base unit 2, the number of microphone 84 may either be one or more.

For example, in a case in which a plurality of microphones 84 are provided in a single base unit 2, the plurality of microphones 84 are disposed at certain (e.g., regular) intervals, and one microphone 84 and one or more flat loudspeaker units 1 placed closest to the microphone 84 make a pair so that the noise canceling sound UN having an opposite phase to the noise N picked up by the microphone 84 is output from the one or more flat loudspeaker units 1 which is paired with the microphone 84.

When the base unit 2 is long, such a case is conceivable in which the level, frequency or the like of the noise differs for every region in the longitudinal direction. However, by placing the plurality of microphones 84 as described above, it is possible to ensure reduction of the noise N which differs in every region.

Moreover, although the microphone 84 which is a separate component from the flat loudspeaker unit 1 is used in the present embodiment, by not using the above-described microphone 84 for example, one of the plurality of flat loudspeaker units 1 or the like having the similar structure to that of the flat loudspeaker unit 1 can also be used instead of the microphone 84.

Further, a portion of the flat loudspeaker unit 1 can also be used as a microphone without using the above-described microphone 84.

For example, one or more coils 126 in the flat loudspeaker unit 1 are electrically disconnected from the other coils 126 (the ones used as the loudspeaker), and the electrically disconnected coils 126 can be used as coils for the microphone while a portion of the diaphragm 1A on which the electrically disconnected coils 126 are formed can be used as a diaphragm of the microphone.

If the microphone 84 is not used in this manner, the number of parts can be reduced.

[Fourth Embodiment]

A fourth embodiment of the present invention will be described hereinafter. The same reference numerals are used to designate identical structures with those of the above-described embodiments, and description thereof will be omitted.

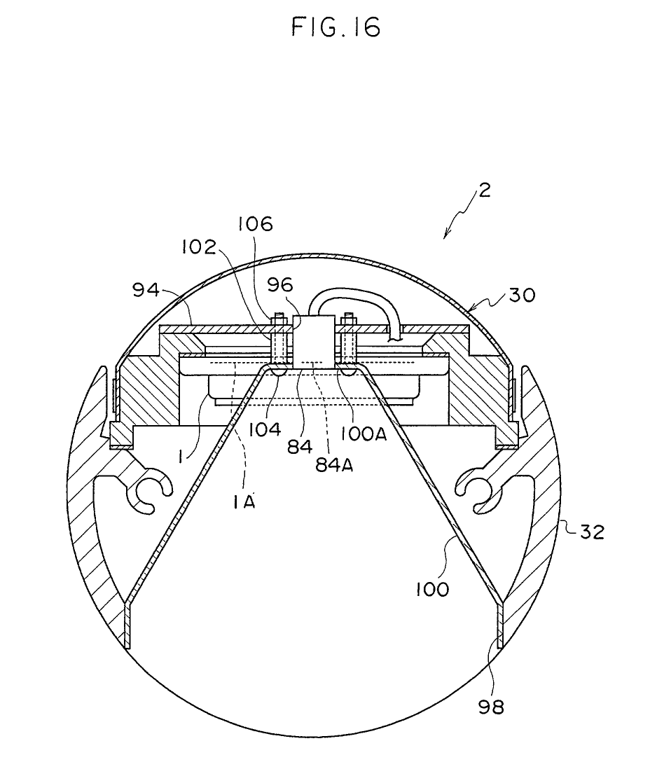

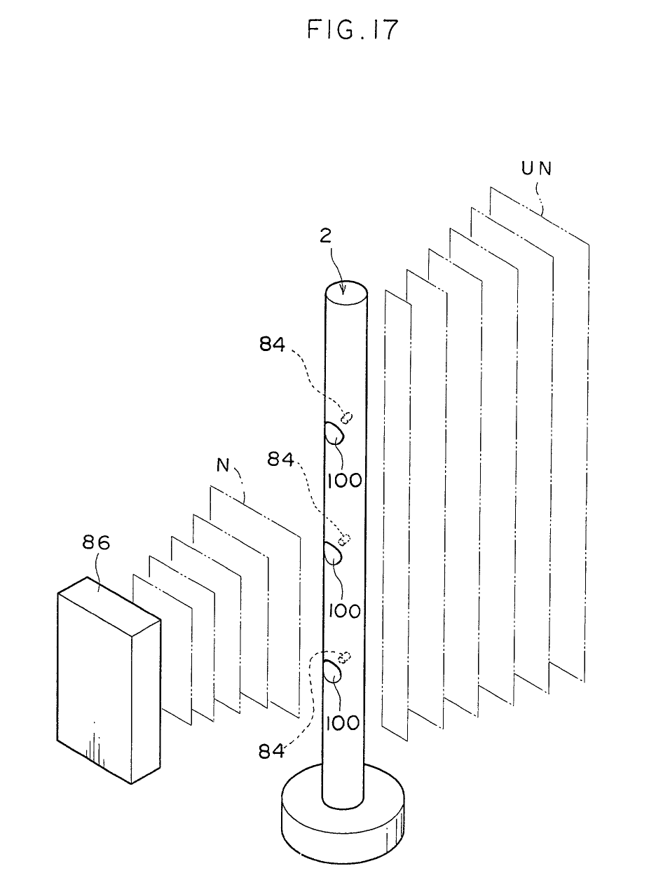

As illustrated in FIG. 16, in the base unit 2 of the present embodiment, a mounting plate 94 is fixed to the baffle board 22 by means of screw or the like.

In the middle of the mounting plate 94, a hole 96 is formed.

In the hole 96, the microphone 84 is inserted and fixed by adhesive or the like.

The microphone 84 is disposed between the two flat loudspeaker units 1.

As illustrated in FIG. 17, in the base unit 2 of the present embodiment, three microphones 84 are placed at regular intervals, and one microphone 84 and two flat loudspeaker units 1 in each of the both sides in the longitudinal direction of the base unit 2 (i.e., four flat loudspeaker units 1 in total) form a pair.

For the microphone 84, a microphone having a diameter as small as possible is used in order to keep intervals between the flat loudspeaker units 1 from becoming wide.

As shown in FIG. 16, a sound receiving surface of the microphone 84 is directed to the backface of the extruded material 32.

The diaphragm 1A of the flat loudspeaker unit 1 and the diaphragm 84A of the microphone 84 are placed in the same plane.

On the backface of the extruded material 32, holes 98 are formed, and a cup-shaped block member 100 is inserted in the holes 98.

The outer peripheral portion of the block member 100 in the vicinity of the opening and the inner peripheral portion of the hole 98 of the extruded material 32 are set into tight contact.

A bottom portion 100A of the block member 100 and the mounting plate 94 are linked together by a spacer 102, a screw 104, and a nut 106.

In accordance with the base unit 2 of the present embodiment, as shown in FIG. 17 for example, the microphone 84 is directed to the noise source 86, the noise N output from the noise source 86 is picked up by the microphone 84, and the noise canceling sound UN having an opposite phase to the picked up noise N is output from the flat loudspeaker 1 to thereby cancel the noise in the front side of the base unit 2.

As described above, the loudspeaker system according to the present invention is suitable for placement in large spaces and for use as a broadcasting equipment in large spaces such in a vicinity of an escalator, on a platform in a station, or at an air port, where it is desirable that the volume and tone of the sound are heard uniformly regardless of listening positions.

Moreover, the noise canceling apparatus according to the present invention is suitable for location in a place where noise reduction is required. For example, it is suitable for mounting on sound-proof walls on a road or the like to reduce the noise of vehicles.

What is claimed is:

1. A loudspeaker system comprising:
an elongated opening provided at a side portion of a cabinet; and
a plurality of flat loudspeaker units, each having a planar diaphragm;
wherein the plurality of flat loudspeaker units are disposed linearly and fixed in the longitudinal direction of the elongated opening to form a base unit.

2. The loudspeaker system according to claim 1, wherein a plurality of said base units are connected.

3. The loudspeaker system according to claim 2, wherein the plurality of base units are connected by means of connecting material.

4. The loudspeaker system according to claim 1, wherein a plurality of said flat loudspeaker units are connected.

5. The loudspeaker system according to claim 1, wherein one or more of the plurality of flat loudspeaker units are mounted to a baffle board to form a baffle board assembly, and a plurality of said baffle board assemblies are connected.

6. The loudspeaker system according to claim 1, wherein a partition is provided in a pipe at each connecting point of the flat loudspeaker units.

7. The loudspeaker system according to claim 1, wherein a sound absorbing material is provided in the interior of the cabinet.

8. The loudspeaker system according to claim 1, further comprising a fixing member for connecting the baffle board on which the flat loudspeaker unit is mounted to the backface of the cabinet, and for fixing said baffle board in the opening portion of the cabinet.

9. A loudspeaker system comprising:
a flat loudspeaker unit having a planar diaphragm; and
a microphone having a diaphragm located in the same plane as the diaphragm of the flat loudspeaker unit.

10. A loudspeaker system comprising a plurality of flat loudspeaker units in which planar diaphragms are located in the same plane, wherein at least one of the plurality of flat loudspeaker units is used as a microphone.

11. A loudspeaker system comprising:
a flat loudspeaker unit provided with a plurality of magnets disposed in the same plane and a planar diaphragm having a plurality of coils which form pairs with the plurality of magnets;
wherein one or more of the plurality of coils are electrically disconnected from the other coils, and the electrically disconnected coils are used as coils for a microphone while a portion of the diaphragm where the electrically disconnected coils are provided is used as a diaphragm of the microphone.

12. A noise canceling apparatus comprising:
a microphone; and
a flat loudspeaker unit which is connected to the microphone and which has a planar diaphragm disposed in the same plane as a diaphragm of the microphone;
wherein the flat loudspeaker unit outputs a sound having an opposite phase to a sound picked up by the microphone.

13. A noise canceling apparatus comprising:
a flat loudspeaker unit having a planar diaphragm;
a microphone having a diaphragm disposed in the same plane as the diaphragm of the flat loudspeaker unit; and
a loudspeaker controller outputting a sound having an opposite phase to a sound picked up by the microphone from the flat loudspeaker unit.

14. A noise canceling apparatus comprising:
a plurality of flat loudspeaker units in which planar diaphragms are disposed in the same plane; and
a loudspeaker controller which utilizes at least one of the plurality of flat loudspeaker units as a microphone and outputs a sound having an opposite phase to a sound picked up by the flat loudspeaker unit used as the microphone from another loudspeaker unit not used as the microphone.

15. A noise canceling apparatus comprising:
a flat loudspeaker unit provided with a plurality of magnets disposed in the same plane and a planar diaphragm having a plurality of coils which form pairs with the plurality of magnets, one or more of the plurality of coils being electrically disconnected from the other coils, the electrically disconnected coils being used as coils for a microphone while a portion of the diaphragm where the electrically disconnected coils are provided is used as a diaphragm of the microphone; and
a loudspeaker controller transmitting electric signals to the other coils in order to output a sound having an opposite phase to a sound picked up by the microphone from a portion of the diaphragm where the other coils are provided.
